(19) United States
(12) Patent Application Publication
(10) Pub. No.: US 2025/0137877 A1
(43) Pub. Date: May 1, 2025

(54) METHOD AND APPARATUS FOR QUALITY CONTROL OF OPHTHALMIC LENSES

(71) Applicant: Schneider GmbH & Co. KG, Fronhausen (DE)

(72) Inventors: Torsten GERRATH, Marburg (DE); Helwig BUCHENAUER, Dautphetal (DE)

(21) Appl. No.: 18/690,967

(22) PCT Filed: Sep. 15, 2022
(86) PCT No.: PCT/EP2022/075668

§ 371 Date: Mar. 11, 2024

(30) Foreign Application Priority Data
Sep. 16, 2021 (DE) 10 2021 123 972.9
Jan. 26, 2022 (DE) 10 2022 000 330.9
May 18, 2022 (DE) 10 2022 112 437.1

(51) Int. Cl. G01M 11/02

(52) U.S. Cl. CPC G01M 11/0264; G01M 11/0278

(57) ABSTRACT

A method or an apparatus for quality control of ophthalmic lenses are proposed, wherein a pattern is imaged through the lens to be controlled and the image is captured by a camera as a raw image, a basic image is generated from several raw images, which is subjected to a cascaded classification, wherein detected defects are quantified according to their intensity and are judged as acceptable or unacceptable by means of at least one quality criterion based on intensity and position, which can be predefined according to customer specifications.

### CROSS-REFERENCE TO RELATED APPLICATIONS

This application is a national stage application under 35 U.S.C. 371 of PCT Application No. PCT/EP2022/075668, having an international filing date of 15 Sep. 2022, which designated the United States, which PCT application claimed the benefit of German Patent Application No. 10 2021 123 972.9, filed 16 Sep. 2021, German Patent Application No. 10 2022 000 330.9, filed 26 Jan. 2022, and German Patent Application No. 10 2022 112 437.1, filed 18 May 2022, each of which are incorporated herein by reference in their entirety.

### BACKGROUND

The present invention relates to a method for quality control, in particular for cosmetic quality control, of ophthalmic lenses, as well as an apparatus for, in particular cosmetic, quality control of ophthalmic lenses, a computer program product and a computer-readable medium.

In the manufacture of ophthalmic lenses, i.e. in particular of spectacle lenses, it is important to control for defects. During such a control, the lens is inspected by specially trained personnel to determine whether certain quality defects or defects (scratches, indentations, incorrect inscriptions, etc.) are present. However, the use of specially trained personnel does not allow objective and cost-effective quality control of ophthalmic lenses.

US 2018/0365620 A1 discloses a method for quality control in the production of ophthalmic lenses, wherein a computable single lens quality criterion is compared with an expected global quality criterion determined by a mathematical model based on a representative set of measured lenses, in particular to identify defective production steps or production machines.

WO 2018/073576 A2 and WO 2018/073577 A2 disclose an arrangement and a method, wherein a test pattern is displayed on a surface and a digital image of the test pattern is captured by a camera through the lens to determine optical parameters of the lens therefrom.

U.S. Pat. No. 7,256,881 B2 relates to a system and method for inspection of ophthalmic lenses, in particular contact lenses. A lens inspection system acquires a plurality of images of each lens being inspected, and analyses each image of the lens to determine whether the lens being inspected has one or more defects or abnormalities. The software provided with the inspection system may categorize the defects detected in or on the lens based on predefined criteria of such defects, for example based on the size, shape or intensity. The algorithm may also be able to classify defects into categories such as particle, scratch, blemish, bubble, fibre, and unknown. Different detection and tracking thresholds can be defined depending on the sensitivity needed for the lens inspection. A cascaded classification or the use of neural networks are not mentioned.

EP 0 491 663 A1 relates to a method and apparatus for examination of optical parts such as spectacle lenses or contact lenses. By using dark field illumination, a high-contrast image is produced. The image areas of detected flaws are divided into pixels. By means of the number of pixels, the extent of a particular flaw is ascertained. The number of pixels ascertained for the individual image areas of the detected flaws is compared with a predetermined number of pixels which is a quality standard which the test specimen has to meet. For the examination, the test specimen can be divided into different zones for which different threshold values are preset as quality standard. A cascaded classification or the use of neural networks are not mentioned.

US 2010/0310130 A1 relates to a Fourier transform deflectometry system and method for the optical inspection of a phase and amplitude object placed in an optical path between a grating and an imaging system. The grating may form a high spatial frequency sinusoidal pattern of parallel straight fringes. The grating may be formed by an active matrix screen such as an LCD screen which allows to alter the pattern without moving the grating. A quality control or classification of defects is not mentioned.

US 2010/0290694 A1 relates to a method and apparatus for detecting defects in optical components such as ophthalmic lenses. The method comprises the steps of providing a structured pattern, recording the reflected or transmitted image of the pattern on the optical component to be tested and phase shifting the pattern and recording again similarly the reflected or transmitted image. On this basis, defects in the optical component can be detected. In particular, a deflectometry measurement using transmission of light is used, wherein a structured pattern is generated on a screen, the generated structured pattern is transmitted by a lens and a camera observes the lens and acquires the transmitted images resulting from the distortion of the structured pattern through the lens. Displacement of the structured pattern may be performed by phase shifting. A cascaded classification or a quality control based on artificial intelligence are not mentioned.

### SUMMARY

It is an object of the present invention to provide a method and an apparatus for the quality control of ophthalmic lenses which enable an optimized and/or objectified quality control, in particular with low computational effort and/or simple adaptation to customer requirements.

The above object is solved by a method according to claim 1 or 9 or by an apparatus according to claim 13, by a computer program product according to claim 14 or by a computer-readable medium according to claim 15. Advantageous further developments are the subject of the subclaims.

The present invention is concerned with the control or quality control of ophthalmic lenses.

An ophthalmic lens to be controlled is subjected to an image generation process, in particular transmissive deflectometry, and a basic image is determined therefrom.

In particular, image generation is performed by imaging a pattern through the lens and recording it as a raw image by a camera. Preferably, several raw images are recorded by varying, in particular offsetting, the pattern. At least one basic image is generated from the raw images.

In addition to the basic image, the lens contour and/or a desired lens shape are optionally also recorded, stored and/or saved in a database. The lens contour and/or lens shape is namely important in that the quality of the lens should meet the desired requirements at least in this area.

According to a first aspect of the present invention, the proposed method preferably comprises the following method steps:
a) Class-specific examination of all pixels of the at least one basic image preferably at least within the lens contour or lens shape and class-specific categorization of each examined pixel according to potential membership in at least one predefined defect class (“In Class”);
b) Assigning at least one value, in particular a numerical value, to each pixel or pixel area for which categorization was possible in step a) (“In Class”);
c) Class-specific examination of each pixel or pixel area from step b) on the basis of the assigned at least one value, in particular numerical value, and class-specific categorization according to membership in—in particular exactly—one predefined defect class;
d) Quantifying the pixels and/or pixel areas assigned to a defect class in step c) according to their intensity;
e) Judging the quantified pixels and/or pixel areas as acceptable or unacceptable based on at least one predefined quality criterion—in particular based on intensity and/or location; and
f) Rejecting the lens(es) with at least one pixel or pixel area judged unacceptable, resulting in automated and objectified quality control.

The proposed process flow allows an optimized and/or objectified quality control with relatively low computational effort. Furthermore, a very simple adaptation to customer requirements is made possible, since a quality criterion or several quality criteria can be predefined very simply and, accordingly, can also be simply adapted to customer requirements.

Preferably, at least two defect classes are predefined as mutually independent main defect classes, in particular the three mutually independent main defect classes “flaw”, “contamination” and “engraving”. This allows an optimal classification of defects and accordingly permits a meaningful and objective assessment of whether a lens is to be considered acceptable or rejected.

It is noted that for the present application, the term “Fehler” from the German priority applications (DE 10 2021 123 972.9, DE 10 2022 000 330.9 and DE 10 2022 112 437.1) is translated as “defect”, the term “Fehlerklasse” is translated as “defect class” and the term “Defekt” is translated as “flaw”.

The aforementioned method steps a), c) and/or d) are preferably carried out by means of at least one class-specific AI system, particularly preferably by means of class-specific neural networks. This means that the AI systems or neural networks for the different classes operate independently, i.e. do not influence each other. This allows an effective classification, wherein a particularly specific defect detection is made possible, since individual defects can be detected independently of others. This results in a higher reliability of the defect detection. Furthermore, this facilitates specific training for individual defects, so that the relevant sensitivity and specificity can be improved very easily and in a targeted manner. Another advantage of independently operating AI systems or neural networks is that the customer can choose which defect classes are to be checked.

A second aspect of the present invention, which may also be implemented independently, provides for the following method steps:
Classifying pixels or pixel areas of the basic image as to whether they fall into at least one of a plurality of defect classes, in particular wherein the pixels or pixel areas classified into a defect class are subjected to a preferably customer-specific judgement as to whether they are acceptable or not,
   wherein the classification is performed by means of class-specific neural networks which operate independently and/or classify only into different defect classes and are or have been trained independently of each other, and/or
   wherein a factory pre-trained classification and/or class-specific quantification of defective pixels or pixel areas according to their defect intensity takes place and a quality criterion, which defect class membership(s) and/or defect intensity (ies) is/are judged to be unacceptable, is specified or can be specified customer-specifically,
Rejecting the lens(es) with at least one pixel or pixel area judged to be unacceptable.

In particular, several independent or separate AI systems or neural networks are used for the different fault classes, which are trained independently of each other. This allows a very accurate detection of individual faults and allows a very simple and targeted training for individual faults, e.g. to increase the sensitivity and specificity in this respect.

The proposed process flow allows a very simple and optimized adaptation to customer requirements for quality control and/or defect control. If the classification into several defect classes and/or a quantification of defects is pre-trained at the factory, a customer-specific quality criterion, namely which defect class membership or defect intensity is judged to be unacceptable, can be customer-specifically specified and/or adapted very simply and with little effort. Accordingly, the method is very universally applicable.

Optionally, the data of the customer-specific quality control can be used to further optimize the factory pre-trained classification and/or class-specific quantification.

A third aspect of the present invention, which can also be implemented independently, provides for the following process steps:
first classifying of all basic images of different lenses and/or of all pixels of the respective basic image at least within one lens contour or lens shape as potentially defective or not,
second classifying, in particular exclusively, of pixel areas consisting only of pixels classified as potentially defective as actually defective or not, and
rejecting the lens(es) with at least one pixel area classified as actually defective, if it is not acceptable.

The proposed process flow allows a significant reduction of computational effort while at the same time providing effective defect detection and is therefore particularly advantageous with regard to high throughput in the inspection of lenses.

A fourth aspect of the present invention, which can also be implemented independently, provides the following method steps:
Quantifying pixels or pixel areas that have already been assigned to a defect class according to the intensity of the defect,
Judging each defect as acceptable or unacceptable based on intensity and preferably location of the defect; and
Rejecting the lens(es) with at least one defect judged to be unacceptable.

The quantification of pixels or pixel areas that have been assigned to a defect class, i.e. are subject to a defect, according to intensity represents a simple and effective way of judging the respective defects in terms of their relevance in the next step.

In general, during quantification preferably only contiguous pixels or pixel areas and/or only pixels or pixel areas of the same defect class are quantified, i.e. assigned a numerical value with respect to the intensity of the corresponding defect.

The preferred judging of in particular only contiguous pixel areas of the basic image to a defect class, in particular subclass, depending on the intensity of at least one detected defect represents a surprisingly effective possibility to be able to judge defects as acceptable or unacceptable—for example on the basis of a customer-specific value scale-in order to then reject those lenses which are judged as unacceptable. This makes it possible in a very simple and effective way to automatically classify defects in terms of their relevance and to establish quality criteria that are, in particular, very easy to adapt to customer-specific requirements.

The present invention further relates to an apparatus for controlling ophthalmic lenses, the apparatus preferably comprising a screen for generating an optical pattern, a holding device for holding a lens to be controlled, and a camera for capturing a raw image based on the pattern imaged by the lens.

According to one aspect of the present invention, the apparatus comprises or is preferably associated with a processing device that generates a basic image from at least one raw image and is adapted to perform a method according to any of the preceding aspects. This provides the corresponding aforementioned advantages.

According to a further aspect of the present invention which can also be implemented independently, the apparatus is preferably configured in such a way that the pattern varies in brightness in an extension direction of the screen, preferably sinusoidally, and patterns which are phase-shifted by 90° can be generated. This allows a very simple and efficient control of the lens, since the different patterns are imaged differently and produce different raw images that can be combined to a basic image, which accordingly contains more information about potential defects of the lens. This is therefore conducive to simple and efficient defect detection and/or quality control.

The aforementioned aspects, features and method steps of the present invention, as well as the aspects, features and process steps resulting from the claims and the following description, can in principle be realized independently of one another, but also in any combination or sequence.

### BRIEF DESCRIPTION OF THE DRAWINGS

Further aspects, advantages, features or characteristics of the present invention will be apparent from the claims and the following description of a preferred embodiment with reference to the figures. It shows:

FIG. 1 a schematic representation of a proposed apparatus for the control of ophthalmic lenses;

FIG. 2 a schematic representation of a raw image; and

FIG. 3 a schematic representation of a basic image.

In the figures, which are not to scale and are merely schematic, the same reference signs are used for the same, similar or like parts and components, wherein corresponding or comparable properties and advantages are achieved, even if a repeated description is omitted.

### DETAILED DESCRIPTION

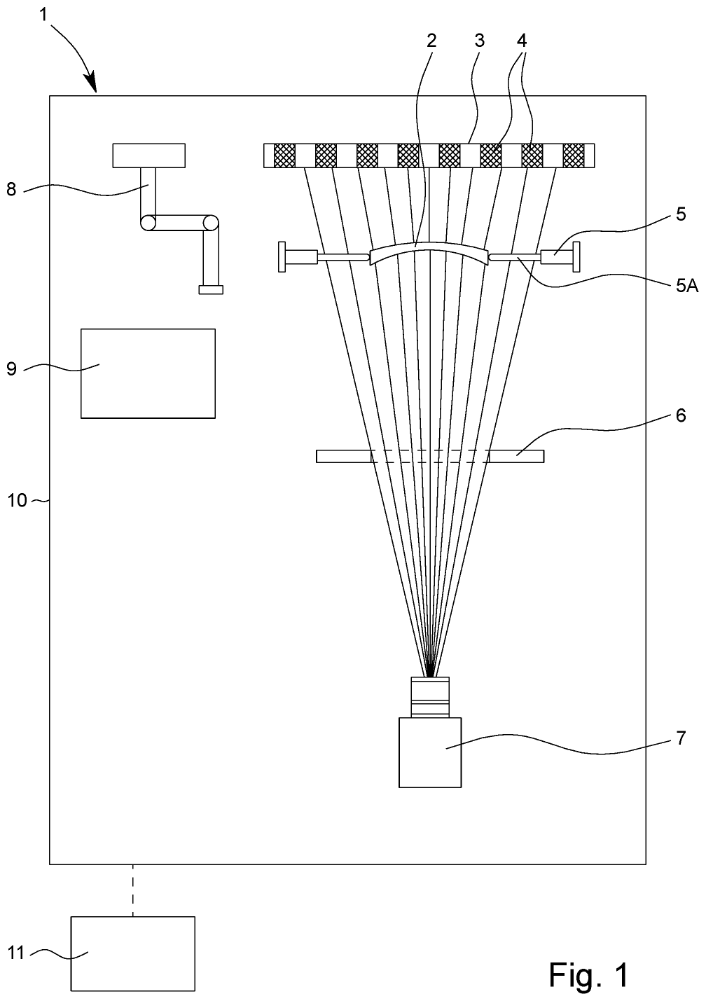

FIG. 1 shows a schematic representation of an apparatus 1 according to the proposal for the control of ophthalmic lenses according to the proposal, in particular quality control or defect control, wherein a lens 2 to be controlled is shown schematically.

The lens 2 is preferably an eyeglass lens, i.e. a lens for eyeglasses. However, it can optionally also be a contact lens.

The lens 2 is preferably made of plastic. However, it is also possible that the lens is made of another material, in particular glass.

The lens 2 preferably has a diameter of several centimeters, in particular more than three centimeters.

The apparatus 1 preferably has a screen 3 for generating a pattern 4, in particular a striped pattern.

The apparatus 1 preferably has a holding device 5 for holding the lens 2, optionally an aperture 6 and in particular a camera 7.

The camera 7 is preferably arranged at a distance from a flat side of the screen 3 and faces the screen 3 and/or pattern 4.

The lens 2 is preferably arranged between the screen 3 and the camera 7 and held in particular by the holding device 5, so that the pattern 4 can be imaged through the lens 2 and recorded or captured by the camera 7 as a raw image. Preferably, this is how the image generation takes place. In particular, therefore, transmissive deflectometry takes place.

The pattern 4 from the screen 3 passes through the lens 2 and is distorted by the (desired) optical effect of the lens 2, but also by possible (unwanted) defects on or in the lens 2. From the distortion, it is possible to infer the defects and thus the quality of the lens 2.

The aperture 6 is preferably arranged between the lens 2 or holding device 5 on the one hand and the camera 7 on the other hand, the diaphragm 6 being only optional.

The apparatus 1 preferably has a manipulation device 8 for handling the lens 2 and/or holding device 5 with the lens 2.

In particular, the manipulation device 8 can pick up the lens 2 directly or indirectly, for example from a not-shown transport carrier on a conveyor belt or the like, and position and/or hold the lens 2 in a desired manner between the screen 3 and the camera 7, in particular at variable distances, for example by means of the holding device 5.

Preferably, the apparatus 1 has a cleaning device 9 that allows cleaning of the lens 2 immediately before image generation.

Preferably, the manipulation device 8 can load the cleaning device 9 with the lens 2 for cleaning and/or, after cleaning, position the lens 2 in the desired manner between the screen 3 and the camera 7 and/or in the holding device 5. However, other constructive solutions are also possible.

The apparatus 1 preferably has a housing 10, which in particular comprises both the components and arrangement for image generation and the cleaning device 9, in order to enable both cleaning and image generation in the common housing 10. However, other constructive solutions are also possible.

The apparatus 1 preferably has a processing device 11. Alternatively, the processing device 11 is preferably assigned to the apparatus 1.

The processing device 11 can be integrated into the apparatus 1 or its housing 10, but can also be separated from it and/or implemented by software, programs, applications, etc.

The processing device 11 may also consist of multiple units or modules and/or be spatially distributed and/or, for example, contain or have access to a database.

The processing device 11 may have a display device not shown, such as a screen, or the like, and/or may be connected to or communicate with other devices, such as a terminal, computer system, or the like.

In particular, the processing device 11 is used for data processing and/or control, for example, whether a controlled lens 2 is rejected or not.

The apparatus 1 and/or processing device 11 is designed in particular for carrying out a method according to the proposal as already explained or described below.

A proposed computer program product comprising instructions for controlling at least one processor to perform one of the proposed methods are stored or kept available, is not shown, but is also a subject matter of the present invention. Further, a computer-readable medium having stored thereon said computer program product is also a subject matter of the present invention.

The present invention or the respective method according to the proposal deals in particular with the control, in particular quality control or defect control, of said lens(es) 2.

The lens 2 to be controlled is preferably first subjected to an image generation process, here in particular transmissive deflectometry, and further image processing. However, this can also be done independently of or before the actual defect or quality control according to the proposal, but it can also be part of it.

### Preferred Image Generation

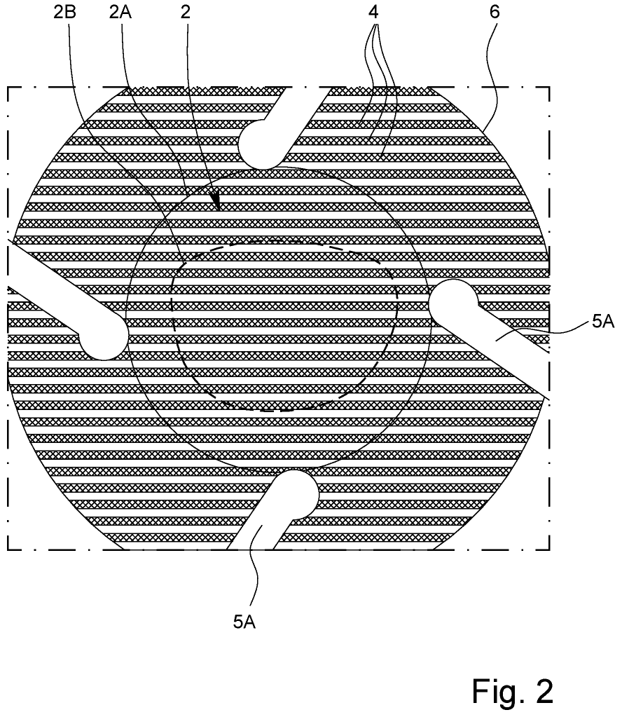

The pattern 4 is imaged through the lens 2. The image is recorded by the camera 7 as a raw image. FIG. 2 schematically illustrates such a raw image as an example.

The recorded or captured raw image is primarily affected by the pattern 4, which is preferably designed here as a striped pattern.

The recorded striped pattern is optionally limited on the outside by the aperture 6.

Furthermore, in the illustration example, holding arms 5A of the holding device 5 are preferably provided and can be seen, which hold the lens 2 in particular on the circumferential side during image generation and can be seen here as corresponding shadows in the raw image shown as an example. However, other constructive solutions are also possible.

Furthermore, FIG. 2 shows the here preferably circular lens contour 2A, which in particular is imaged as well.

In addition, for illustrative purposes only, a lens shape 2B is indicated by way of example, representing a possible or desired subsequent shape of the lens 2 for a particular pair of eyeglasses.

The pattern 4 is preferably designed as a line or stripe pattern and has brightness values that vary preferably sinusoidally in a transverse direction—in FIG. 2 from top to bottom (this corresponds to a vertical sine wave), which is only indicated very schematically in FIG. 2. For this reason, it is also referred to briefly as a sine pattern.

Preferably, the pattern 4 is shifted along its sinusoidal course or brightness course in steps, preferably by 90° or a quarter of the wavelength in each case, and different raw images are recorded correspondingly.

Thus, four shifts of the sine pattern and/or the stripes result in four different raw images.

Further, the pattern 4 is preferably rotated by 90° so that, taking into account the phase offset, another four raw images are preferably captured.

Furthermore, the sinusoidal frequency of the pattern 4 (not the wavelength of the light) can also be varied. For example, corresponding raw image sequences are recorded or captured by the camera 7 at different, in particular three different frequencies.

In particular, depending on the number of shifts and/or the number of sine frequencies, a varying number of raw images can be created and/or further processed into one basic image or several basic images.

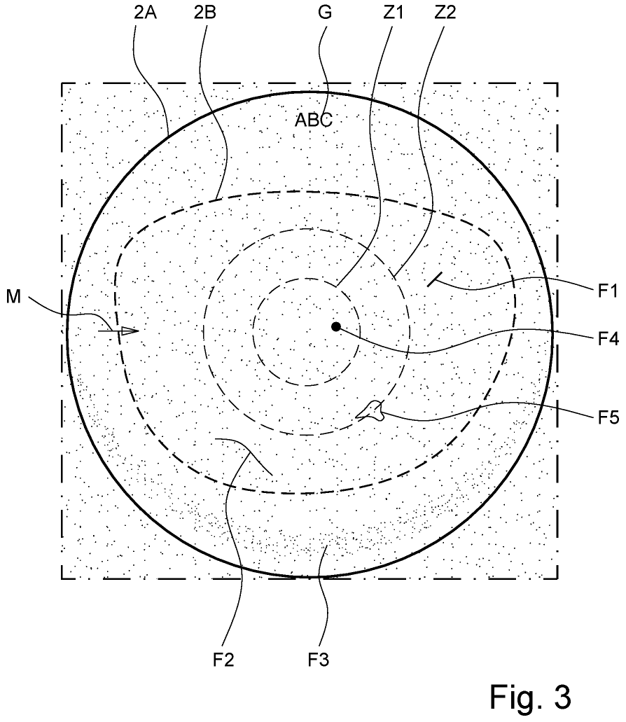

The various raw images are further processed to form at least one basic image, in particular several basic images, for example 10 to 50 basic images per lens 2. FIG. 3 shows such a basic image very schematically.

### Preferred Further Image Processing

The further image processing includes an image pre-processing and optionally an image post-processing. First, a preferred image pre-processing is discussed in more detail.

In particular, in the preferred embodiment, several basic images, in particular three basic images for β (gray level mean values), γ (scattering) and ϕ (phase) are determined from the four raw images resulting from the phase shift in an alignment auf the pattern 4.

In particular, the determination is based on the following formulas:

$$β = \frac{{I}_{1} + {I}_{2} + {I}_{3} + {I}_{4}}{4 {I}_{Sat}} \\ γ = \frac{\sqrt{{( {I}_{1} - {I}_{3} )}^{2} + {( {I}_{2} - {I}_{4} )}^{2}}}{2 β {I}_{Sat}} \\ ϕ = {tan}^{- 1} ( \frac{{I}_{3} - {I}_{1}}{{I}_{4} - {I}_{2}} )$$

The values I₁ to I₄ refer to the intensity of the pixels—in particular their gray values—of the raw images 1 to 4, which are caused by the phase shift of the sine pattern (four per orientation) vertically or horizontally.

Iₛₐₜ refers to the possible maximum value of the intensity, here the maximum possible value or gray value of the pixels or the camera 7.

Accordingly, there is one basic image each for β, γ and ϕ per orientation (vertical or horizontal) of the pattern 4.

The values of β and γ determined for the horizontal and vertical sinusoidal patterns 4 are added vectorially. The values for ϕ are added numerically.

This results in each case in a range of values and/or basic image for β, γ and ϕ for a sinusoidal pattern 4 at one frequency. In other words, three basic images are formed.

If several records and/or raw images of the same sine pattern 4 are taken with the same shift—in particular for noise reduction—the gray values of the individual pixels are preferably added and the sum is used in the respective formula. In addition, different sine patterns 4, in particular with three different sine frequencies, can be used.

In the case of β and γ, the values then determined at the various sine frequencies are averaged.

In case of the relative phase ϕ a beat frequency is calculated via the three sine frequencies and the absolute phase is determined by means of deconvolution (different methods are possible here).

The basic image is preferably a grayscale image.

In particular, a basic image always correlates uniquely to a particular lens 2.

This completes image pre-processing of the further processing.

Optionally, image post-processing can follow.

During image post-processing, the basic images are preferably filtered. This can be done using known filters, for example average filters, edge filters, clipping or the like.

Thus, the basic images are generated and/or provided, in particular, from image recording, capturing of raw images, image preprocessing (processing to at least one basic image), and optional image post-processing (e.g., filtering).

The basic images are preferably kept available or stored in a database or in some other way, wherein additional information on optical values of the lens, engravings, polarization, coloring, lens contour 2A, desired lens shape 2B or the like can also be stored and/or taken into account in the further or proposed control and/or in the image generation, image pre-processing and/or image post-processing and/or the further subsequent steps for evaluating the basic images.

In the following, methods and method steps according to the proposal for the control, in particular defect control and/or quality control, of the lenses 2 to be controlled are explained, wherein the steps explained below are preferably carried out by the apparatus 1 and/or processing device 11, i.e. automatically.

The basic image(s) are further examined in various steps, as explained below, to determine the defects and to check or control the quality of the lens 2.

Preferably, a first classification is carried out initially.

Preferred first classification (pixel classification).

Preferably, all pixels of the respective basic image at least within the lens contour 2A or the desired lens shape 2B are first examined and classified as to whether they fall into at least one predefined defect class, in particular wherein this first classification or categorization is evaluated only as potential membership in the at least one defect class.

If only the pixels within the lens contour 2 or lens shape 2B are examined and classified, the required computation time can be minimized.

For reasons of simplification, however, an examination and classification of all pixels of the respective basic image can also be carried out.

Depending on the resolution, it may be useful, particularly at very high resolution, to examine only pixel groups or mean values of pixel groups in order to enable faster examination and/or classification. The term “pixel” should therefore preferably be understood in the sense that it also refers to a group of pixels that are treated as a single pixel in the steps explained below and/or, if applicable, also in the image preprocessing and image post-processing described.

The classification is preferably performed by means of an AI system, particularly preferably by means of a neural network, for each defect class independently. In particular, independent or separate neural networks are thus used for the individual defect classes, in short also referred to as class-specific AI system or class-specific neural networks.

An aspect of the present invention and the method according to the proposal that can also be implemented independently is that the classification is performed independently for the different defect classes (main classes and/or subclasses, as will be explained in more detail later).

Particularly preferably, classification is thus carried out by class-specific networks which are trained independently of each other for a specific defect class in each case. This makes it very easy to improve the specificity and sensitivity with respect to a particular defect without affecting the detection of other defects. This has proven to be very advantageous especially with respect to efficient training.

The first classification or pixel classification determines whether the examined pixels or areas of pixels belong to one or more predefined classes (defect classes), wherein this classification or categorization is to be understood only as a potential membership in a defect class.

In particular, in the first classification it is only determined that the respective pixels or pixel areas are potentially subject to a defect if they have been classified, i.e. categorized, into at least one defect class. The final determination as to whether a defect is present is only made later, in particular by means of a (separate) second classification.

The defect classes are preferably predefined. These are in particular main classes preferably with different subclasses in each case.

In particular, main classes such as “contamination”, “flaw”, “engraving” or the like are defined as defect classes.

The defects are classically understood, for example, as scratches, haze or the like. Exemplary defects F1 and F2 are indicated in FIG. 3 as scratches and defect F3 as haze.

The defect F4 may represent, for example, a depression, and the defect F5 may be regarded, for example, as an area of local refractive change and/or scattering.

The defects can also be further subdivided as to whether they cause a local refractive change or local scattering.

Corresponding subclasses for the main class(es) are preferably defined.

In the case of engravings and markings, errors can occur, for example, because they are present twice, are too strong or too weak, or are irregularly executed, or are located in the wrong place or have the wrong orientation. In this respect, too, corresponding subclasses are preferably defined. FIG. 3 only schematically shows an engraving G and a marking M.

Therefore, a large number of subclasses are preferably formed for the various main classes.

In the first classification, it is also possible, if necessary, that only a classification according to the main classes is carried out. It is even optionally possible that only a classification into a single overall class with the statement “potentially defective” is carried out, even if the main classes and/or subclasses are optionally examined.

For the first classification, class-specific, i.e. independent AI systems or neural networks can optionally be used only for the main classes. Preferably, however, these are used for all classes and/or for most or all subclasses.

Preferably, the brightness values or gray values of the individual pixels of the basic images form the input values for the classification.

After the first classification, preferably only those basic images are further examined and/or evaluated for which pixels or pixel areas have been classified into at least one of the predefined defect classes (main class and/or subclass), i.e. have been categorized as potentially belonging to at least one defect class.

In particular, all basic images and thus the associated lenses 2 are judged to be free of defects and/or acceptable if no pixels or pixel areas have been classified as potentially belonging to a defect class in the first classification.

Particularly preferably, in the further evaluation and/or examination, only those pixels or pixel areas that were classified as belonging to a defect class in the first classification are examined.

The next step is preferably a feature detection (feature extraction), in particular limited to the pixels and/or pixel areas previously classified as potentially defective.

### Preferred Feature Detection

The feature detection (feature extraction) uses a plurality of predefined feature algorithms to assign numerical values to the potentially defective pixels and/or pixel areas, corresponding to different examined features.

In particular, different values, especially numerical values, are assigned to the pixels and/or pixel areas depending on the feature and/or feature algorithm.

The term “values” preferably refers to any mathematical system suitable for evaluating the features examined by means of the feature algorithms. In particular, it can be alphanumeric values.

For example, in a feature algorithm, the number of contiguous pixels (all previously classified as potentially defective) is counted. This represents a measure of size or area.

Further, in another feature algorithm, for example, the ratio of area (number of contiguous pixels) to perimeter (number of adjacent, not potentially defective pixels or the edge pixels) can be determined. This represents a measure of shape (e.g., elongated or squat). However, such ratios and relationships can also be recognized and used by the AI system or neural network through appropriate training. Then it is sufficient for this aspect if the feature algorithms determine the area and the perimeter.

Optionally, one or each feature algorithm is applied to only those pixels of the same defect class or subclass that are classified as potentially defective. However, it is also possible that some or all feature algorithms examine and evaluate, i.e. assign a numerical value to, the pixels of several or all subclasses, in particular limited to one main class, but possibly also of several or all main classes.

In the value assignment, therefore, predetermined feature algorithms are preferably used to assign a numerical value to, for example, gray scale values, gray value gradients, length, width, height, area, shapes, contours and the like according to predetermined calculation rules. Each feature algorithm provides a value, for example the number of pixels forming an area, or a value derived by a formula. Optionally, the numerical value can also be normalized. Preferably, this is a purely mathematical process (especially without a neural network), which provides pure values that are later further processed.

The various values of the different feature algorithms flow differently into the evaluation of whether pixels or pixel areas fall into a particular defect class or not. For example, several thousand, in particular 5,000 to 8,000 feature algorithms are available and/or taken into account, wherein for classes to be examined individually, for example, only 100 to 500 or 200 to 300 feature algorithms or their value are included.

The pre-selection by the first classification preferably leads to a substantial reduction of the required computing time, since only the pixels and/or pixel areas potentially belonging to at least one defect class are examined by means of the feature algorithms and/or subjected to the assignment of numerical values.

According to one embodiment, only pixel areas are provided with a numerical value for the respective feature during feature detection. Then, preferably, only these pixel areas are subjected to further examination or the further process.

In particular, a pixel area then consists only of pixels that have previously been classified as potentially defective, especially only in the same main class or subclass.

A pixel area then preferably consists only of contiguous pixels.

The feature detection thus leads to an assignment of (optionally normalized) numerical values to pixels and/or pixel areas for the various features.

This is followed by a further examination, in particular the second classification already mentioned. Here, in particular, the previously assigned numerical values are used for a class-specific categorization according to membership in at least one predefined defect class. In particular, the numerical values previously calculated using the various feature algorithms are taken into account here depending on the respective class.

### Preferred Second Classification (Area Classification)

Preferably, only those pixels and/or pixel areas—in particular exclusively pixel areas—are subjected to the second classification which have previously been classified as potentially defective and/or to which a value has been assigned during feature detection and/or which lie within a specific area, such as the lens contour 2A or lens shape 2B.

The second classification is preferably carried out by class-specific AI systems or neural networks, especially preferably comparable to the first classification, which operate independently or separately for each class, so that in particular class-specific training is enabled independently and without influencing the judgement of other defect classes.

In particular, the second classification is thus designed in such a way that the evaluation with respect to one defect class does not influence the evaluation of the other defect classes and/or the detection of one defect class can be trained independently without influencing the detection of other defect classes. As already mentioned, this is realized in particular by using completely independent or separate neural networks.

By means of the second classification it is determined whether certain pixels or pixel areas and thus a certain basic image and consequently the associated lens 2 definitely belong to a defect class, i.e. have a defect, e.g. also an incorrect engraving or marking, or not.

Of course, individual pixels or pixel areas and/or different pixels or pixel areas can also belong to different defect classes, i.e. have multiple defects.

The second classification can use the same classes (main and/or subclasses) as the first classification. However, in principle, another classification can be used in the second classification.

In particular, the second classification may use a finer classification, for example, with more subclasses than the first classification.

Preferably, (only) the numerical values assigned during feature detection form the input values for the second classification.

The preferably provided cascaded classification (first and second classification with optional feature detection before the second classification) represents an aspect of the method according to the proposal or of the present invention which can also be realized independently and enables a particularly reliable or safe defect detection and thus good and/or safe quality control with a manageable computational effort.

Next, preferably only those pixels or pixel areas—in particular exclusively (contiguous) pixel areas—are further examined which have been classified and/or categorized into at least one defect class, i.e. which definitely show a defect. Preferably, this is limited to pixels and/or pixel areas that are located in a relevant area, e.g. within the lens contour 2A of the lens shape 2B.

Particularly preferably, the next step is a quantification of the detected defects according to their intensity.

### Preferred Quantification

Preferably, in a further or next step, the pixels and/or pixel areas previously classified into a defect class are quantified according to the strength and/or intensity of the various defects. This is done in particular class-specifically for the individual defect classes.

This quantification is preferably again based on the values of the feature algorithms and/or feature detection, in particular of only individual or specific feature algorithms or values with respect to the respective defect class. Thus, each detected defect of the lens 2 can be assigned an intensity, in particular in the form of a numerical value, which reflects the strength and/or quality of the respective defect.

Preferably, the numerical values and/or intensities assigned during quantification are normalized, for example from 0 to 100.

For example, the numerical value can indicate the intensity of how a certain defect, such as a scratch, is perceived. This depends partly on criteria that are easy to measure, such as the length of the scratch, but also on values that are very difficult to measure, such as the depth, width or steepness of the flanks of a scratch.

For example, the scratch according to defect F1 could be quantified as 43.

In the case of engravings, for example, not only the intensity is decisive, but factors such as the uniformity or the position are also relevant in order to be able to recognize an engraving well or poorly. For example, an engraving can also be too uneven or be in the wrong place or even show the wrong character. The same applies to markings, for example.

Particularly preferably, only for contiguous pixels for which a classification into the same defect class has been made or a defect has been or is detected, a quantification (of the defect) according to intensity is performed.

Of course, a basic image or lens 2 may have several different scratches or other defects that fall into the same or different defect classes. All these defects correlate to certain examined pixels or pixel areas and are preferably accordingly quantified separately, i.e. class-specific and/or independently of each other.

The quantification is preferably done by an AI system or neural network, in particular to learn by appropriate training with which strength and/or intensity the different errors are perceived by humans.

Preferably, the many feature detection values are used here to derive the different intensities for the various defects.

If necessary, separate neural networks can again be used, which are trained independently for individual or specific defect classes.

It should be noted that the class-specific neural networks can, for example, each be directed or trained to a main class or, alternatively, only to a subclass falling below it or, if necessary, also to several subclasses falling below a main class and then serve accordingly only for the respective classification.

In particular, each pixel and/or pixel area that has already been classified as definitely belonging to a defect class is thus assigned a value with respect to the quality and/or strength of the defect by said quantification.

For the quantification, in particular the values already assigned and/or determined by means of the feature algorithms are used, in particular at least insofar as they are relevant for the respective quantification and/or respective defect. In particular, these values are used as input values for the AI system or neural network.

During quantification, the location of a defect can optionally also be taken into account, for example as explained later for the preferred defect judgement and/or location categorization. Alternatively or additionally, however, this is preferably done during defect judgement.

Optionally, the (second) classification or area classification and the quantification can also be performed in one step.

In a further step, a particularly customer-specific status classification and/or defect judgement is preferably carried out, in which the lenses classified as defective are judged as acceptable or unacceptable.

### Preferred Defect Judgement

The judgement is also preferably automated.

The judgement is preferably based on the fact that the intensity of a defect is taken into account, if necessary taking into account the location of the defect, in particular by means of predetermined limit values or ranges.

For example, values from 0 to 100 are assigned during quantification.

For example, a scratch such as F1 can be rated such that a value of 0 to 20 is neglected, a value of 21 to 40 is classified as “weak,” a value of 41 to 70 is classified as “medium,” and a value of 71 to 100 is classified as “strong.” A scratch with a value of 43 would then be classified as “medium” according to this scale. With a different scale, for example for a different customer or customer-specific and/or product-specific, the defect with the value 43 could be classified as “weak”. This results in an defect categorization (based on the error intensity).

Preferably, a or each defect is categorized based on the intensity assigned to it with a predeterminable and/or adaptable and/or customer-specific scale. This represents a preferred aspect of the present invention and/or of the method according to the proposal, which can also be implemented independently.

In particular, different defects can be partially or all categorized using different scales. Furthermore, the location of the defect can optionally be taken into account, for example whether the defect or scratch is located e.g. in a central zone Z1, as schematically indicated in FIG. 3, or in a further zone Z2 (which is shown here as a ring zone around Z1, for example) or outside of it.

For example, only negligible scratches may be acceptable in zone Z1, only weak scratches may be acceptable in zone 2, and only medium scratches may be acceptable outside of it (but possibly still within lens contour 2A or lens shape 2B).

If a flaw or defect, for example a scratch, extends over several zones, the judgement or grading is preferably performed for each zone or only for the most important one.

For example, defect F4 is located in the central zone Z1, where at most weak defects are tolerable. Defect F4, although relatively small or point-like, is clearly visible, so that it would probably be classified as medium or strong and therefore no longer acceptable.

If, on the other hand, defect F4 were located outside zone Z2 or outside the later lens shape 2B, for example, this defect F1 could probably still be judged acceptable, if necessary.

The defects F1 and F2 lie outside the zone Z2 in the illustrational example, but still within the (later) lens shape 2B. Here again, it depends on the quality criterion whether these defects are to be classified as acceptable or unacceptable depending on their strength and position.

Defect F3 is characterized by an accumulation of in particular darker pixels (for example, it is a haze) and may be acceptable, for example, in particular because it is relatively close to the edge or outside the lens shape 2B.

The position and/or number of zones etc. is or are preferably predeterminable and/or adaptable and/or customer-specific.

The automated judgement of whether a defect is acceptable or not is preferably based on a predefinable and/or adaptable and/or customer-specifically definable quality criterion, which defect category is optionally to be considered acceptable or not depending on the location (in particular inside or outside certain zones).

In particular, the quantification and/or intensity of the respective defect and, if applicable, its location are thus taken into account in the quality criterion, wherein the preferred defect categorization simplifies the establishment and adaptation of the quality criterion.

If the locations of the defects are taken into account, the preferred zone specification (categorization of location), which may also be defect-specific, can also simplify the establishment and adaptation of the quality criterion.

Accordingly, automated judgement can be performed very easily, and in particular does not require neural networks or prior training.

Preferably, different scales, zones and/or quality criteria are specified or defined for the different defects. These can also vary depending on product categories and/or quality classes.

The judgement criteria (scales, zones, quality criteria) are very easy to adapt and predefine, especially customer-specific and/or product-specific.

Accordingly, the apparatus 1 according to the proposal and the method according to the proposal can be used very universally and can be adapted very well to the respective circumstances.

Thus, a judgement can be made in a very simple manner as to whether detected defects, and thus ultimately the lens 2, are judged to be acceptable or unacceptable.

### Rejecting an Unacceptable Lens

The lenses judged to be unacceptable are rejected. This is done automatically and is controlled in particular by the apparatus 1 and/or processing device 11.

Rejecting lenses 2 judged to be unacceptable may involve subjecting them to additional processing or correction, which is in particular performed by a machine or manually.

Rejecting may also result in the unacceptable lens 2 being diverted from the production process and, in particular, disposed of.

Rejecting lenses 2 judged to be unacceptable may include marking, rejecting, discharging, and/or displaying them.

### Training Data

The AI systems and/or neural networks—before they are used for quality control of lenses 2 in production—are preferably first trained with training data, in particular already at the factory before delivery to the customer.

As already mentioned at the beginning, the training for different defect classes is preferably performed separately or, for different defect classes, AI systems and/or neural networks are preferably trained independently of each other for the respective defect class.

The training of an AI system and/or a neural network basically proceeds in such a way that first one or more training data sets are created, each training data set having or consisting of training data in the form of basic images or sections of basic images of lenses 2, as exemplarily shown in FIG. 3. Each basic image or a group of associated basic images of a training data set is preferably assigned a classification target (“target”). In the classification target, the defect(s) of the respective basic image or section are classified and/or quantified. The classification target thus contains the information about the defect(s) present in the basic image or the lens 2 associated with the basic image. The classification target of a basic image or section can therefore be, for example, “no defect” (or “NotInClass”, in particular as an expression for the fact that no defect is present in the defect class to be trained), “potential defect” or “defect” (or “InClass”, in particular as an expression for the fact that—at least potentially—an error is present in the defect class to be trained) and/or contain further information about the defect(s) present, for example information about intensity (in particular in the form of a numerical value), type, strength, position of the defect or the like.

Preferably, at least for the first classification, also basic images of defect-free lenses 2 are used in the training data sets, so that the respective AI system and/or neural network also learns to recognize defect-free lenses 2.

The individual lenses 2 whose basic images are used for training may each have no defect, one defect or several defects. The defects of a single lens 2 can all fall into the same but also into different defect classes, in particular the defect classes “flaw”, “contamination” and/or “engraving”.

For training, the basic images or sections of the training data set(s) are passed to the respective AI system or neural network. The AI system or neural network then performs a classification and/or quantification of the defects for each of the basic images or sections. The classification and/or quantification performed by the AI system or neural network is then compared to the classification target. The deviations between the quantification and/or classification performed by the AI system or neural network and the classification target are communicated to the AI system or neural network, so that by repeated application of this method in a manner known per se, training of the AI system or neural network for the detection of defects takes place.

Particularly preferably, a class-specific training of different AI systems and/or neural networks is performed. In the class-specific training, the respective AI system or neural network is trained to detect and/or quantify only errors of a specific defect class. This is done in particular by the fact that-even if a basic image for training should contain errors of several classes—the classification target only contains information about the defect of the class to be trained and/or only the defect of the class to be trained is noted as defect in the classification target (or “InClass”) and/or defects from other classes than the class to be trained are noted in the classification as “no defect” (or “NotInClass”).

Thus, if, for example, a basic image contains a defect of the class “flaw” and a defect of the class “engraving” and training is to be performed on the class “flaw, the classification target in this case preferably only contains information on the defect of the class “flaw” and/or only the defect of the class “flaw” is marked as “InClass” and/or the defect from the class “engraving” is marked as “NotInClass”. Accordingly, in a training data set for training the class “engraving”, the classification target of the same basic image preferably contains only information about the defect of the class “Engraving” and/or only the defect of the class “Engraving” is marked as “InClass” and/or the defect from the class “flaw” is marked as “NotInClass”.

In this way, even when using the same training data sets and/or basic images for the different defect classes, separate training of the class-specific AI systems and/or neural networks can be performed, and/or the use of different training data sets and/or basic images for the different AI systems and/or neural networks can be dispensed with. In particular, due to the class-specific classification targets, learning is performed in a class-specific manner in each case.

The class-specific training ensures that the AI systems and/or neural networks for the different (defect) classes operate independently and/or do not influence each other.

The training procedure is now explained again by way of example using FIG. 3. The basic image shown in FIG. 3 contains various defects F1 to F5, each representing flaws, as well as an engraving G and a marking M and can represent a basic image of a training data set.

Now, if an AI system or neural network is to be trained on the class “flaw”, the classification target of the basic image preferably only contains information on the defects that represent a defect, and/or only defects of the class “flaw” are marked as “InClass” and/or the defects from other classes are marked as “NotInClass”. In the example from FIG. 3, therefore, the classification target would preferably contain information only about the defects F1 to F5, which represent defects in each case (in particular “InClass”). No information would be included for the engraving G and the marking M, or the information would be included that the marking M and the engraving G do not represent a defect or a flaw (in particular “NotInClass”). Thus, the AI system or neural network is specifically trained to detect only defects in the class “flaw” and/or to ignore defects in other classes, such as “contamination” or “engraving”. If, for example, the engraving G were detected as a defect during the training of the class “flaw”, the AI system or neural network would receive the feedback that the engraving G does not represent a flaw or a defect of the class “flaw” to be trained (“NotInClass”), so that it is learned in this way that engravings G are not flaws.

If an AI system or neural network is to be trained on the “contamination” class, the classification target of the basic image preferably only contains information on the defects that represent a contamination, and/or only defects of the class “contamination” are marked as “InClass” and/or the defects from other classes are marked as “NotInClass”. In the example from FIG. 3, therefore, the classification target would preferably contain no information about the defects F1 to F5, which each represent flaws, and about the engraving G and the marking M, or it would contain the information that the defects F1 to F5, the marking M and the engraving G do not represent a defect of the class “contamination” (in particular “NotInClass”). Thus, the AI system or neural network is specifically trained to detect only defects of the class “contamination” and/or to ignore defects in other classes, such as “flaw” or “engraving”. If, for example, the engraving G were detected as contamination during the training of the class “contamination”, the AI system or neural network would receive the feedback that the engraving G does not represent a contamination or a defect of the class “contamination” to be trained, so that it is learned in this way that engravings G are not contaminations.

For other defect classes, also other than the classes “flaw”, “contamination” and “engraving” mentioned here as examples, the above applies analogously, of course.

Furthermore, training is preferably done not only for main defect classes, but also for subclasses and/or quantification of defects.

In particular, in the present invention, as explained above, a first classification or pixel classification, a second classification or area classification, and/or a quantification are preferably performed, in particular by means of an AI system and/or neural network in each case.

The neural networks and/or AI systems for the first classification, the second classification and the quantification are preferably trained separately and/or with separate and/or different training data or training data sets.

The training data set(s) for the first classification preferably contain(s) as training data complete basic images or basic images in which all pixels and/or pixel areas or at least all pixels and/or pixel areas within the lens contour 2A or the lens shape 2B are contained. In this case, the classification target preferably contains information about which pixels and/or pixel areas potentially contain defects belonging to the class on which the respective neural network or AI system is to be trained.

The training data set(s) for the second classification preferably contain(s) as training data sections of basic images with pixels and/or pixel areas that are potentially defective and/or that lie within a certain area, in particular the lens contour 2A or the lens shape 2B. In this case, the classification target preferably contains information about which pixels and/or pixel areas definitely contain defects belonging to the class on which the respective neural network or AI system is to be trained.

The training data set(s) for quantification preferably contain(s) as training data sections of basic images with pixels and/or pixel regions containing defects. In this case, the classification target preferably contains information about the strength and/or intensity of the respective defects, in particular in the form of numerical values for the respective defects.

It is also possible that the training datasets for the different AI systems or neural networks each contain the same basic images and differ only in the classification targets.

The different training sets and/or classification targets enable a targeted and efficient training of the respective AI systems and/or neural networks for the respective tasks to be performed (in particular first classification, second classification and quantification).

### General Remarks

The classification of whether defects are present, i.e. whether pixels and/or pixel areas fall into certain defect classes, is preferably trained or specified at the factory.

The same applies preferably to the quantification of the detected defects.

In the case of scratches and similar defects, it depends on the intensity, i.e. how strongly or weakly a scratch is perceived by people at the end of production. This is also related to the process step in which the scratch is checked, since a subsequent coating, for example, can still positively influence the perceptibility of a scratch, i.e. reduce it. The extent to which a scratch is perceived depends in part on criteria that are easy to measure, such as the length of the scratch, but also on values that are difficult to measure, such as the depth or width of the scratch or the steepness of the flanks. The physical causes of the effect are also only partially directly measurable. However, the complex interaction of, for example, a change in gray value can be taken into account, since a heavy scratch usually appears darker than a light scratch. These different aspects are covered by the feature algorithms and can be taken into account accordingly during quantification.

The quantification is accordingly complex, since a great many different numerical values of the various feature algorithms interact to be able to ultimately quantify the intensity and/or quality of a defect. Accordingly, a definition and/or training at the factory is very advantageous and preferred.

In principle, it is also possible, for example in step e) of claim 1, to use a neural network to define the quality criteria. However, the disadvantage would then be that corresponding examples have to be trained for all possible defects and strengths as well as positions. This takes a lot of time and is therefore not very practical.

During classification, feature detection and/or quantification and/or by the neural networks and/or feature algorithms, different basic images, i.e. values, are preferably used and/or combined for the examination of individual pixels or pixel areas.

In a preferred embodiment, preferably a plurality of basic images or pixels or pixel areas thereof, in particular of more than 10 basic images, particularly preferably of more than 20 basic images, are used or evaluated per lens 2, in particular for further processing, first classification, feature detection, second classification, quantification and/or judgement.

An aspect of the method according to the proposal which can also be implemented independently is that, for the classification of pixels or pixel groups of the basic image as to whether they fall into at least one of a plurality of defect classes here, independent neural networks are used, wherein only one neural network is assigned to each class and, preferably conversely, only one class is assigned to each neural network and wherein the neural networks operate and/or are trained or have been trained independently of one another. This allows a specific training of the individual neural networks for the detection of the specific defects and in particular allows to increase the sensitivity for the detection of specific defects very easily without affecting the other defect detection.

A further aspect of the method according to the proposal which can also be implemented independently is that a factory pre-trained classification according to defects and in particular also a determination of the intensity of the defects takes place and that the assessment of whether lenses are judged to be acceptable or unacceptable can be predefined and/or adapted on a customer-specific basis. This enables a very universal use of the method according to the proposal and the apparatus 1 according to the proposal.

Another aspect of the method according to the proposal that can also be implemented independently is the cascaded classification. This enables a particularly reliable defect detection with low computational and/or time requirements.

In particular, a cascaded classification can also be used within a defect class or in a classification step, and/or even in the first or second classification, for example by multiple neural networks are used or classify in succession.

Furthermore, defective pixels or pixel areas are preferably combined into associated defect regions and/or classified and/or quantified as associated defects depending on the intensity of the defects.

The described sequence of steps is preferred, but not mandatory. In particular, individual steps can also be performed in parallel or two steps in one.

Individual aspects and method steps can be combined as desired, but can also be implemented independently of each other.

### LIST OF REFERENCE SIGNS

1 Apparatus
2 Lens
2A Lens contour
2B Lens shape
3 Screen
4 Pattern
5 Holding device
5A Holding arm
6 Aperture
7 Camera
8 Manipulation device
9 Cleaning device
10 Housing
11 Processing device
F1 Defect
F2 Defect
F3 Defect
F4 Defect
F5 Defect
G Engraving
M Marking
Z1 Central zone
Z2 Further zone

1-15. (canceled)

16. A method for quality control of ophthalmic lenses,
wherein at least one ophthalmic lens is subjected to at least one image generation process and at least one basic image is generated therefrom,
the method comprising the further method steps:
a) class-specific examination of at least substantially all pixels of the at least one basic image at least within the lens contour or lens shape and class-specific categorization of each examined pixel according to potential membership in at least one predefined defect class (“In Class”);
b) assigning at least one value, in particular a numerical value, to each pixel or pixel area for which categorization was possible in step a) (“In Class”);
c) class-specific examination of each pixel and/or pixel area from step b) on the basis of the assigned at least one value and class-specific categorization according to membership in a predefined defect class;
d) class-specific quantification of at least one or each pixel and/or pixel area assigned to a defect class in step c) according to its intensity;
e) judging each pixel and/or pixel area quantified in step d) as acceptable or unacceptable on the basis of at least one predefined quality criterion; and
f) rejecting the lens(es) with at least one pixel and/or pixel area judged to be unacceptable, so that an automated and objectified quality control results.

17. The method according to claim 16, wherein the basic image is stored or saved in a database.

18. The method according to claim 17, wherein the basic image is stored or saved in the database with at least one imaged lens contour or desired lens shape.

19. The method according to claim 16, wherein class-specific categorization according to membership in exactly one predefined defect class is performed in step c).

20. The method according to claim 16, wherein the at least one predefined quality criterion in step e) is involves intensity and/or location.

21. The method according to claim 16, wherein at least two defect classes are predefined as independent main defect classes.

22. The method according to claim 16, wherein three independent main defect classes “flaw”, “contamination”, “engraving” are predefined.

23. The method according to claim 16, wherein the steps a), c) or d) are carried out by least one class-specific AI system or class-specific neural networks.

24. The method according to claim 23, wherein the at least one class-specific AI system or the neural networks is/are trained before the method is carried out in such a way that in step e) a possible erroneous judging as acceptable or unacceptable converges towards zero when the method is carried out.

25. The method according to claim 23, wherein the at least one class-specific AI system or the neural networks is/are trained in advance before the method is carried out and is/are further trained during a repeated execution of the method in such a way that in step e) a possible erroneous judging as acceptable or unacceptable converges towards zero in the course of the execution of the method.

26. The method according to claim 16, wherein in step e) at least one predefined customer-specific quality criterion is used in such a way that additionally a customer-specific quality control of each lens results.

27. The method according to claim 16, wherein in step e) at least one predefined quality category is used as quality criterion.

28. The method according to claim 16, wherein the quality control is a cosmetic quality control.

29. The method according to claim 16, wherein an optical pattern is generated on a screen and at least one raw image is captured by a camera, from which at least one basic image is generated.

30. A method for the control of ophthalmic lenses,
wherein at least one basic image is used or determined, the basic image being based on a lens to be controlled being subjected to an image generation process and the basic image being determined and/or generated therefrom,
the method further comprising:
first classifying of all basic images of different lenses and/or all pixels of the respective basic image at least within a lens contour or lens shape as potentially defective or not,
second classifying of pixels and/or pixel areas consisting only of pixels previously classified as potentially defective as actually defective or not, and
rejecting the lens(es) with at least one pixel area classified as actually defective, if it is unacceptable.

31. The method according to claim 30, wherein the image generation process is or comprises transmissive deflectometry.

32. The method according to claim 30, wherein an optical pattern is generated on a screen and at least one raw image is captured by a camera, from which at least one basic image is generated.

33. The method according to claim 32, wherein the raw image is based on the pattern imaged by the lens, wherein the pattern varies in brightness in an extension direction.

34. The method according to claim 33, wherein patterns phase-shifted by 90° are generated and corresponding raw images are captured.

35. A method for the control of ophthalmic lenses,
wherein at least one basic image is used or determined, the basic image being based on a lens to be controlled being subjected to an image generation process and the basic image being determined and/or generated therefrom,
the method further comprising:
i) classifying pixels or pixel groups of the basic image whether they fall into at least one of several defect classes,
wherein the classification is performed by class-specific neural networks which operate independently and/or classify only into different defect classes and are or have been trained independently of each other, and/or
wherein a factory pre-trained classification into defect classes and/or a quantification of defective pixels and/or pixel areas according to their defect intensity takes place, and wherein a quality criterion, which defect class membership(s) and/or defect intensity (ies) is/are judged to be unacceptable, is or can be specified customer-specifically,
rejecting the lens(es) with at least one pixel or pixel area classified as defective and/or judged as unacceptable;
and/or
ii) quantifying pixels or pixel areas that have already been assigned to a defect class according to the intensity of the respective defect,
judging each defect as acceptable or unacceptable based on intensity and preferably location of the defect; and
rejecting the lens(es) with at least one defect judged to be unacceptable.
